(19) United States
(12) Patent Application Publication
(10) Pub. No.: US 2012/0092580 A1
(43) Pub. Date: Apr. 19, 2012

(54) CONTROLLING SPACING BETWEEN DISPLAY AND REINFORCEMENT LAYER

(75) Inventor: Rajesh Manohar Dighde, Redmond, WA (US)

(73) Assignee: MICROSOFT CORPORATION, Redmond, WA (US)

(21) Appl. No.: 12/904,025

(22) Filed: Oct. 13, 2010

(51) Int. Cl. G02F 1/1333; H01J 9/24

(52) U.S. Cl. 349/58; 445/24

(57) ABSTRACT

Embodiments are disclosed herein that relate to the reinforcement of a display panel. One disclosed embodiment provides a method of manufacturing a reinforced display panel, wherein the method comprises applying a fluid adhesive layer over one of a display panel and a protective layer, placing the other of the protective layer and the display panel in contact with the adhesive layer, maintaining a spacing between the display panel and the protective layer via a plurality of spacers dispersed within the adhesive layer spatially across an area between the display panel and the protective layer, and curing the adhesive layer.

### BACKGROUND

An interactive display device, such as a surface computing device, may interact with a user through a surface of an object, as compared to a monitor, keyboard or other such input and output devices. Various types of touch-sensing mechanisms, including but not limited to optical and capacitive touch-sensing mechanisms, may enable the sensing of multiple temporally overlapping touches on the interactive surface as well as object recognition. This may allow for the recognition of touch-based and gesture-based inputs, thereby providing for a rich user experience.

Some interactive display devices may utilize display panels, such as liquid crystal display (LCD) or organic light emitting device (OLED) panels, to display images to users. However, such display panels may not have sufficient durability for long-term use as a touch-interactive surface.

### SUMMARY

Various embodiments are disclosed herein that relate to the reinforcement of a display panel. For example, one disclosed embodiment provides a method of manufacturing a reinforced display panel, wherein the method comprises applying a fluid adhesive layer over one of a display panel and a protective layer, placing the other of the protective layer and the display panel in contact with the adhesive layer, maintaining a spacing between the display panel and the protective layer via a plurality of spacers dispersed within the adhesive layer spatially across an area between the display panel and the protective layer, and curing the adhesive layer.

This Summary is provided to introduce a selection of concepts in a simplified form that are further described below In the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an embodiment of an interactive display device.

FIG. 2 shows a flow diagram depicting an embodiment of a method for reinforcing a display panel.

FIG. 3 shows a schematic depiction of a sequence of changes made to an embodiment a display panel during an embodiment of a reinforcing process.

FIG. 4 shows a schematic depiction of a sequence of changes made to another embodiment of a display panel during another embodiment of a reinforcing process.

FIG. 5 shows a flow diagram depicting another embodiment of a method for reinforcing a display panel.

FIG. 6 shows a schematic depiction of an embodiment of a display panel at various instances while performing the method of FIG. 5.

### DETAILED DESCRIPTION

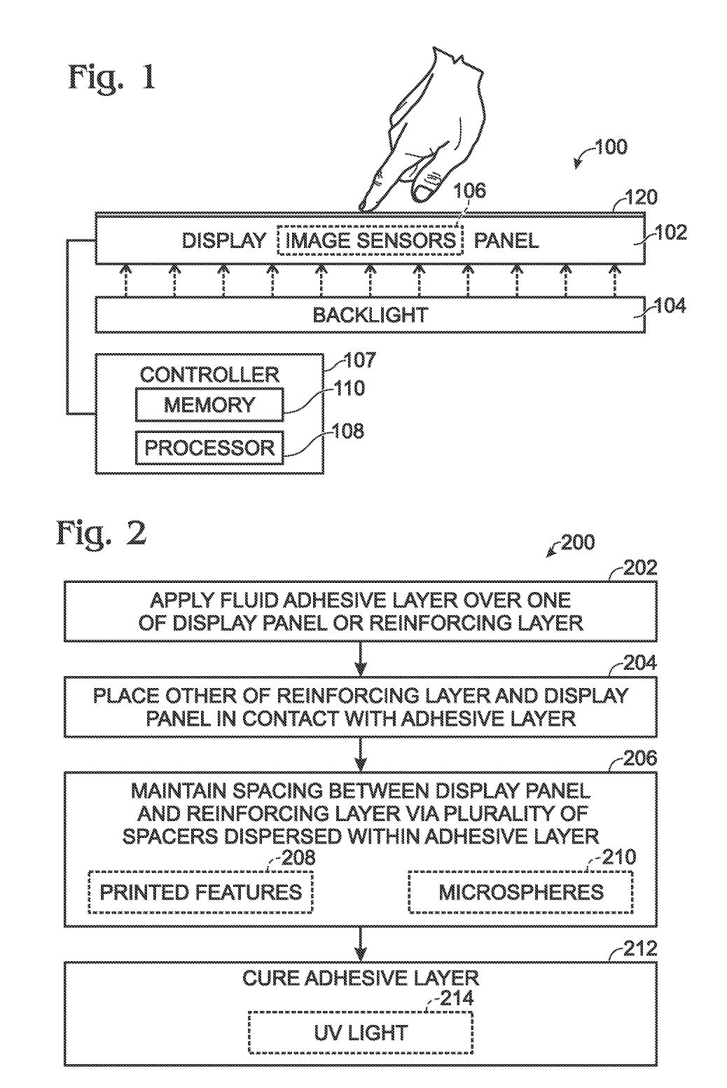

FIG. 1 shows an example embodiment of an interactive display device 100 configured to sense touch and/or objects. Interactive display/sensing device 100 (hereinafter “interactive display device”) comprises a display panel 102, such as an LCD panel or the like. The depicted interactive display device 100 further comprises a backlight 104 configured to direct light toward the display panel 102. The backlight may also be of the edgelit type. It will be understood that backlight the 104 may be omitted where an emissive displaypanel, such as an OLED panel, is used.

The interactive display device 100 further comprises a plurality of image sensors 106 incorporated into the display panel, wherein the image sensors are configured to detect objects in proximity to and/or touching the surface of the display panel 102. A display panel comprising such image sensors may be referred to as a sensor-in-pixel display panel. The interactive display device 100 further comprises a controller 107 having a processor 108 or other logic device or devices, and memory 110 having instructions stored thereon that are executable by the processor 108 to control the display of images by display panel 102 and to detect and interpret touch inputs via images acquired by image sensors 106. It will be understood that other embodiments may utilize image capture devices other than a sensor-in-pixel arrangement, such as one or more infrared cameras located behind the display panel relative to the position of a user that are capable of detecting infrared light that passes through the display panel. Further, yet other embodiments may utilize capacitive, resistive, in cell capacitive and other touch, sensing technologies.

As described above, display panels, including but not limited to LCD panels, may lack sufficient durability for long-term use as a touch-interactive surface. Therefore, a protective layer 120 may be placed over and bonded to the display panel 102 to increase the lifetime the interactive display device 100. As such, the materials selected for use as protective layer 120 may be selected for desired levels of optical transparency and durability. Examples of suitable materials for protective layer 120 include, but are not limited to, chemically strengthened glasses. Protective layer 120 also may be selected to avoid impacting dimensional and mechanical tolerances of the display panel 102 and to avoid impacting touch/sensing sensitivity.

However, the touch, sensing, and/or display properties of a surface interactive device all may depend on the uniformity of protective layer with respect to the display/sensing surface. For example, in the sensor-in-pixel arrangement of interactive display device 100, a protective layer that is not uniformly spaced from the LCD panel may impact the quality of images acquired by the image sensors 106. Such nonuniformity also may affect other vision-based detection systems than a sensor-in-pixel system, as well as capacitive touch-sensing systems and other touch-sensing technologies. In the case of vision-based touch sensing, nonuniformities in spacing may result in areas of the protective layer surface being out of focus, may introduce parallax errors in an acquired image, and/or may create mura (surface defects). Further, the existence of bubbles and other gaps in the adhesive layer used to hold the protective layer to the display panel may create scattering sites noticeable to a user.

In order to avoid bubbles and other gaps in the adhesive layer an optically clear, curable liquid may be used to bond the protective layer to the display panel, as opposed to a pressure-sensitive adhesive or the like. Further, precise control of the thickness of the adhesive layer may help to increase the uniformity of the edge-to-edge quality of an image acquired by a vision-based touch system. Some methods of bonding a protective layer to a display panel involve the use of a peripheral dam to retain the adhesive and also to act as a spacer to control the distance separating the protective layer and the display panel. However, on large format displays, the center of the protective layer may sag while the adhesive cures, thereby leading to nonuniform thickness of the adhesive layer. This problem may worsen as the display size increases. Such issues also may impose a lower boundary on the thickness of the adhesive layer, as too thin an adhesive layer may allow areas of the protective layer and the display panel to touch, thereby disrupting bonding, and may not account for non planarity of surfaces.

Accordingly, various embodiments are disclosed herein that relate to maintaining a desired uniformity of thickness of an adhesive layer used to bond a protective layer onto a display panel. FIG. 2 shows a flow diagram depicting an example embodiment of a method 200 of bonding a protective layer to a display panel. Method 200 comprises, at 202, applying a fluid adhesive layer over the display panel or protective layer (depending upon whether the protective layer is applied to the display panel from above, or vice versa). It will be understood that a gasket, dam or other suitable structure may be used to define a region to which the adhesive is applied so that the adhesive is contained within the gasket or dam. Method 200 then comprises, at 204, placing the other of the protective layer or display panel in contact with the adhesive layer.

As mentioned above, maintaining uniform spacing between the protective layer and the display panel may help to avoid various imaging issues in a vision-based touch detection system. Therefore, method 200 next comprises, at 206, maintaining a spacing between the display panel and the protective layer via a plurality of spacers dispersed within the adhesive layer. The plurality of spacers are configured to have a same size within a desired level of tolerance, and are distributed spatially across an area between the display panel and the protective layer such that the distance between the two structures is maintained by the spacers during the adhesive curing process. Method 200 next comprises, at 212, curing the adhesive to form the reinforced display. The adhesive may be cured in any suitable manner, including but not limited to via exposure UV light 214, visible light, electron beam, thermal and/or infrared energy, etc.

The spacers may take any suitable form that does not unsuitably degrade the optical properties of the adhesive layer. For example, in some embodiments, the spacers may take the form of printed features 208 that are printed onto the surface layers (e.g. polarizers) of the display panel and/or the surface of the protective layer. The printed features may be configured to have a uniform height within desired tolerances, and may be printed at a spatial density suitable to maintain the spacing between the protective layer and the display panel at a desired level of uniformity. Further, the printed features may be formed from a material or materials with a refractive index close to or equal to the refractive index of the cured adhesive material to avoid causing unwanted reflections and refractions of light at the boundaries of the printed features and cured adhesive. In some embodiments, the indices of refraction of the adhesive after curing and the printed features are within +/−0.01 of one another.

Further, in some embodiments, a same material is used to form the printed features and the adhesive layer. In such embodiments, the cured adhesive and printed features may have substantially the same refractive index (with possible minor variations depending upon the concentration and nature of any additives used in the two structures). This may render the boundaries between the printed features and the cured adhesive unnoticeable during ordinary use of the display panel. In other embodiments, the adhesive and printed features may be formed from different materials. Any suitable material may be used for the printed features and adhesive layer. In some embodiments, both the printed features and the adhesive layer comprise poly(methyl methacrylate) (PMMA). Other examples of suitable materials include, but are not limited to, polyurthanes, epoxies, and cyanoacrylates.

In other embodiments, the spacers may take the form of a plurality of microspheres 210 that are added to the fluid adhesive before the adhesive is applied over the display panel or protective layer. The microspheres may be configured to have a highly uniform diameter distribution such that the display panel and protective layer are maintained at a uniform spacing across the entire area covered by the fluid adhesive. The microspheres may be added to the fluid adhesive material in any suitable concentration. Suitable concentrations include concentrations that provide a desired amount of support per unit area across the surface of the protective layer or display panel, and that does not increase or otherwise unsuitably impact the viscosity of the fluid adhesive layer. In the case of a PMMA adhesive comprising PMMA microspheres, examples of suitable concentrations of microspheres may include, but are not limited to, concentrations in the range of 1-10% by volume. The use of such microspheres may simplify manufacturing, as no separate step need be performed to form or place the spacers on the display panel or protective layer prior to adhesive application.

As described above for the printed feature spacers, the microspheres 210 may be made from any suitable material. Suitable materials include, but are not limited to, materials with a refractive index close to or equal to the refractive index of the cured adhesive material to avoid causing unwanted reflections and refractions of light at the boundaries of the microspheres and cured adhesive. In some embodiments, the indices of refraction of the adhesive after curing and the microspheres are within +/−0.01 of one another. Further, in some embodiments, a same material is used to form the microspheres and the adhesive layer, while in other embodiments, the adhesive layer and the microspheres are formed from different materials, with proper consideration to the thermal expansion mismatch.

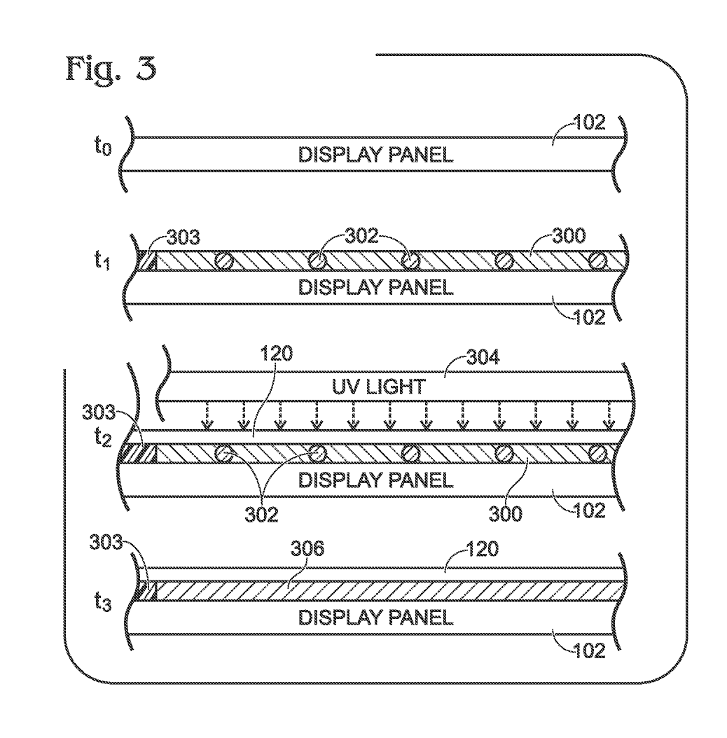

FIG. 3 shows a schematic depiction of the display panel 102 at various stages during a reinforcement process that utilizes a fluid adhesive comprising microspheres to bond the protective layer 120 to the display panel 102. The display panel 102 is shown prior to reinforcement at t₀. Next at t₁, the display panel 102 is shown after the addition of the adhesive layer 300 comprising the microspheres 302, wherein the adhesive layer 300 is contained within an area defined by a gasket 303. It will be understood that, although FIG. 3 shows only a portion of the gasket 303, the gasket 303 may fully enclose the area to which the fluid adhesive is applied. As illustrated, it can be seen that the microspheres 302 are spatially distributed across an area between the display panel 102 and the protective layer 120, and thereby help to maintain a uniform distance (within desired tolerances) between these structures. Next, at t₂, the protective layer 120 is placed over the adhesive layer 300, and then the adhesive layer 300 is exposed to ultraviolet light from ultraviolet light source 304 (or other suitable energy source). It will be understood that additional processes, such as the application of a roller, may be used during curing in some embodiments. Upon curing, as illustrated at t₃, the similarity of the refractive indices of the adhesive material and the microsphere material in the cured adhesive layer 306 may render the boundaries difficult or impossible to distinguish by eye.

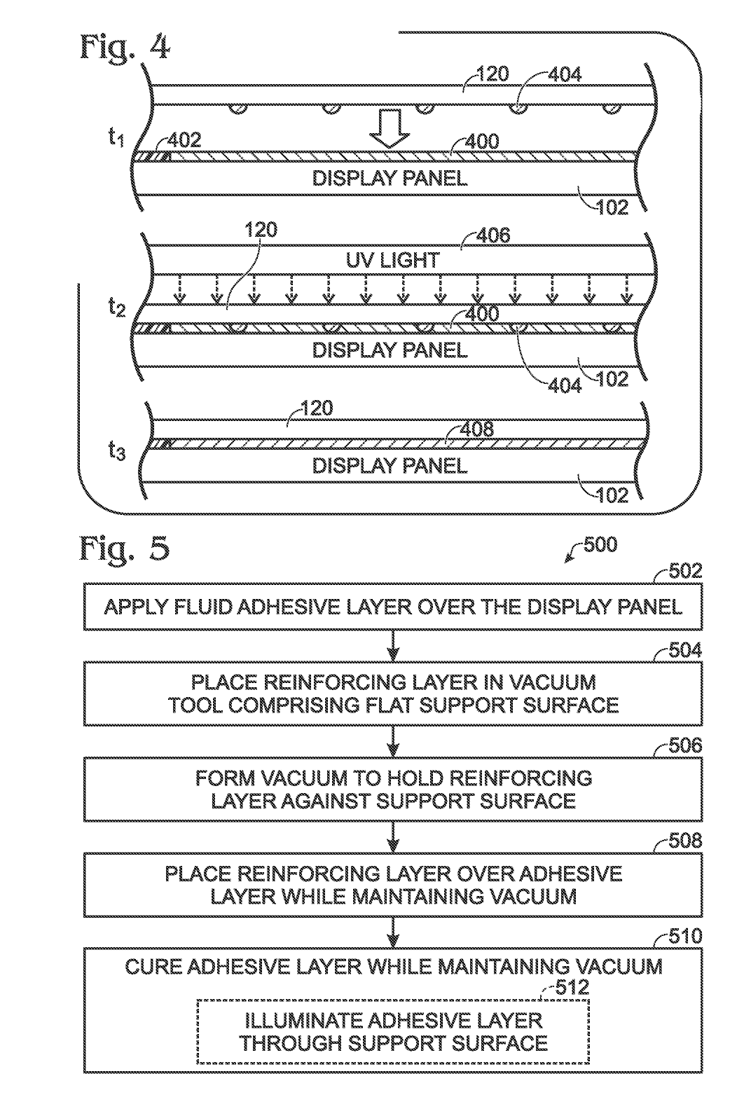

FIG. 4 shows a schematic depiction of the display panel 102 at various stages during performance of a embodiment of a reinforcement process that utilizes printed features, as opposed to microspheres, to maintain a uniform distance (within desired tolerances) between the display panel 102 and the protective layer 120 during the bonding process. At t₁, the display panel 102 is shown after the addition of the fluid adhesive layer 400, which is contained within an area defined by a gasket 402. It will be understood that, although FIG. 4 shows only a portion of gasket 402, gasket 402 may fully enclose the area to which the fluid adhesive is applied. Further, the protective layer 120 is shown positioned over the fluid adhesive layer 400. As illustrated, the printed features 404 are printed on the protective layer 120, but it will be understood that the printed features 404 also may be printed onto the display panel 102, or may comprise pre-printed on the polarizers present on the display panel.

Next, at t₂, the protective layer 120 is shown applied to the fluid adhesive layer 400 such that the printed features 404 are spatially distributed within the fluid adhesive layer across an area between the display panel 102 and the protective layer 120, thereby helping to maintain a uniform distance between these structures. This is maintained while the adhesive layer 400 is illuminated with ultraviolet light from ultraviolet light source 406 (or other suitable energy source). Upon curing, as illustrated at t₃, the similarity of the refractive indices of the adhesive material and the printed feature material in the cured adhesive layer 408 cause the boundaries to become difficult or impossible to distinguish by eye. The printed features of the embodiment of FIG. 4 may be formed in any suitable manner, including but not limited to screen printing and ink jet printing.

In the embodiments of FIGS. 2-4, placing the spacers physically between the protective layer and the display panel may allow a uniform adhesive layer thickness to be achieved within desired tolerances without holding the protective layer and display panel in special tooling configured to keep these structures flat and parallel during curing. This may simplify the manufacture of even very large reinforced displays. Further, it will be noted that the spacing between the protective layer and display panel may be varied by simply modifying the size of the spacers (e.g. by printing thicker printed features or including microspheres of a different diameter in the adhesive). This may allow for the adhesive layer to be varied for various use scenarios. For example, a thicker protective layer and correspondingly thinner adhesive layer for greater impact strength may be achieved with smaller microspheres or printed features, while a thinner protective layer and correspondingly thicker adhesive layer may help to allow for the use of an expansion-mismatched protective layer and display panel.

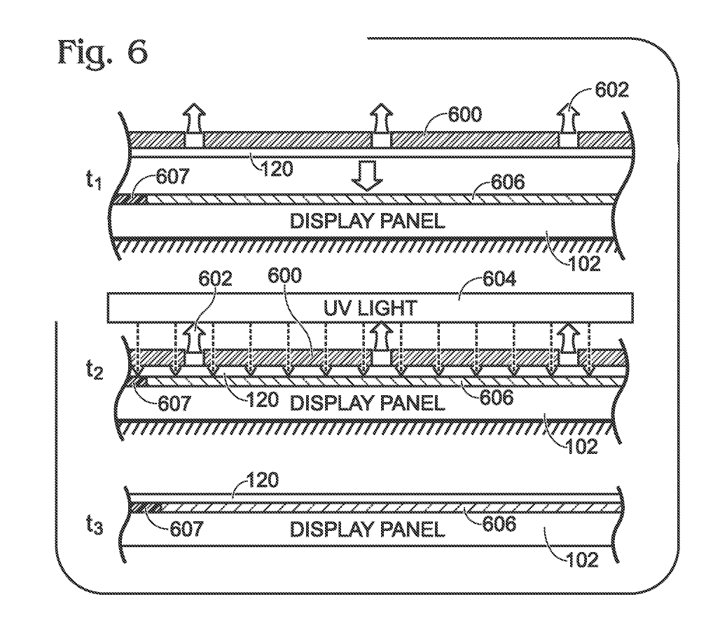

The embodiments illustrated in FIGS. 2-4 utilize structures located in the adhesive layer between the display panel 102 and the protective layer 120 to maintain the separation between these layers. FIGS. 5 and 6 illustrate embodiments of methods of forming an adhesive layer of a uniform thickness that utilize features external to the area between the display panel 102 and the protective layer 120 to maintain a uniform spacing between the display panel 102 and the protective layer 120 during curing. First referring to FIG. 5, an embodiment of another method 500 of forming a reinforced display panel is shown. Method 500 comprises, at 502, applying a fluid adhesive layer over a display panel. At 504, method 500 comprises placing a protective layer in a vacuum tool that comprises a flat support surface.

Referring briefly to FIG. 6, an example of a support surface 600 is shown at t₁. The support surface 600 comprises one or more vacuum ports 602 that allow a vacuum to be drawn in the space between the support surface 600 and the protective layer 120. The flat support surface may be formed from any material that can be made with a suitably flat profile. Examples of support surface materials include, but are not limited to, flat glass materials such as float glass, as well as rigid polymers (e.g. a rigid polymer cast on a float glass molding surface). An adhesive layer 606 is also shown applied to the display panel, wherein the adhesive layer is retained by a spacer dam 607. In some embodiments, the spacer dam 607 may comprise a precision-formed rigid material configured to fix the distance between the display panel 102 and the protective layer 120. In other embodiments, the spacer dam 607 may be formed from a flexible material, and spacing between the display panel and the protective layer 120 may be maintained by other mechanical or control mechanisms.

Referring again to FIG. 5, method 500 comprises, at 506, forming a vacuum to thereby hold the protective layer against the flat support surface. Then, at 508, method 500 comprises placing the protective layer over and in contact with the adhesive layer while maintaining the vacuum, and at 510, curing the adhesive layer while maintaining the vacuum. As described above, the adhesive layer may be cured in any suitable manner, including but not limited to by directing light (e.g. UV or visible) through the flat support surface, or by exposing to heat, electron beam, or other suitable energy source. Where the adhesive layer is cured by exposure to light, the support surface may be configured to be transparent to wavelengths of light used to cure the adhesive so that the adhesive layer may be illuminated through the flat support surface, as indicated at 512. For example, a float glass support surface may be transparent to visible or ultraviolet light. Likewise, where the adhesive layer is thermally cured, the support surface may be configured to be mechanically stable and robust at the curing temperatures used.

Referring again to FIG. 6, the display panel 102 may be placed on and held against a display panel support surface, indicated as a cross-hatched surface below the display panel in FIG. 6, during a reinforcement process to ensure that the display panel is also held flat during the adhesive curing process. It will be understood that the support surface 600 for the protective layer and the display panel support surface may be configured to be parallel.

Next, at time t₂, the protective layer 120 is placed against the adhesive layer 606, and UV light (or visible light or other energy) is transmitted through the support surface 600 and the protective layer 120 to cure the adhesive layer, thereby forming cured adhesive layer 608 at t₃.

Forming a reinforced display panel as disclosed herein may help to provide a highly uniform and coplanar interactive surface, versus a surface with localized variations. This may provide for reliable vision-based touch detection, and also may help to achieve consistent drop impact, static load properties across the entire viewing surface compared to a less uniform surface.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of manufacturing a reinforced display panel, the method comprising:
applying a fluid adhesive layer over one of a display panel and a protective layer;
placing the other of the protective layer and the display panel in contact with the adhesive layer;
maintaining a spacing between the display panel and the protective layer via a plurality of spacers dispersed within the adhesive layer spatially across an area between the display panel and the protective layer; and
curing the adhesive layer.

2. The method of claim 1, wherein maintaining the spacing between the display panel and the protective layer comprises maintaining the spacing via a plurality of printed features on one or more of the display panel and the protective layer.

3. The method of claim 2, wherein maintaining the spacing between the display panel and the protective layer comprises maintaining the spacing via printed features on the protective layer.

4. The method of claim 2, wherein the printed features comprise a refractive index within +/−0.01 of an index of refraction of the adhesive layer after curing.

5. The method of claim 1, wherein maintaining the spacing between the display panel and the protective layer comprises maintaining the spacing via microspheres contained within the fluid adhesive layer.

6. The method of claim 5, wherein applying the fluid adhesive layer comprises applying a fluid adhesive comprising 1-10% microspheres by volume.

7. The method of claim 5, wherein the microspheres comprise a refractive index within +/−0.01 of an index of refraction of the adhesive layer after curing.

8. The method of claim 5, wherein the microspheres and the adhesive layer comprise a same material.

9. The method of claim 1, wherein curing the adhesive comprises curing the adhesive via exposure to ultraviolet light.

10. The method of claim 1, wherein applying the fluid adhesive layer comprises applying a liquid adhesive into a region within a gasket.

11. A method of manufacturing a reinforced display panel, the method comprising:
applying a fluid adhesive layer over the display panel;
placing a protective layer in a vacuum tool comprising a flat support surface and vacuum ports configured to form and maintain a vacuum between the flat support surface and the protective layer;
forming a vacuum with the vacuum tool, thereby holding the protective layer against the flat support surface of the vacuum tool;
placing the protective layer over the adhesive layer while maintaining the vacuum; and
curing the adhesive layer while maintaining the vacuum.

12. The method of claim 11, wherein curing the adhesive layer comprises exposing the adhesive layer to one or more of ultraviolet and visible light.

13. The method of claim 12, wherein exposing the adhesive layer to one or more of ultraviolet and visible light comprises directing light through the flat support surface.

14. The method of claim 13, wherein directing light through the flat support surface comprises directing the light through a float glass surface.

15. The method of claim 11, wherein the display panel is an LCD panel or an OLED panel.

16. A reinforced display panel, comprising:
a display panel configured to display an image;
a protective layer bonded to the display panel; and
an adhesive layer located between the display panel and the protective layer, the adhesive layer comprising a plurality of spacers dispersed within the adhesive layer spatially across an area between the display panel and the protective layer, wherein the spacers are formed from a material having a refractive index within +/− 0.01 of the refractive index of the adhesive layer.

17. The reinforced display panel of claim 16, wherein the adhesive layer and the spacers are formed from poly(methyl methacrylate).

18. The reinforced display panel of claim 16, wherein the spacer comprise a plurality of printed elements.

19. The reinforced display panel of claim 16, wherein the spacers comprise a plurality of microspheres.

20. The reinforced display panel of claim 16, wherein the reinforced display panel is incorporated in an interactive display device.
